(19) United States
(12) Patent Application Publication
(10) Pub. No.: US 2011/0185859 A1
(43) Pub. Date: Aug. 4, 2011

(54) CORKSCREW

(76) Inventor: Ramon Brucart-Puig, Castellarnau (ES)

(21) Appl. No.: 12/863,993

(22) PCT Filed: Oct. 3, 2008
(86) PCT No.: PCT/ES08/00623

§ 371 Date: Nov. 1, 2010

(30) Foreign Application Priority Data
Jan. 22, 2008 (ES) P200800146

(51) Int. Cl. B67B 7/00

(52) U.S. Cl. 81/3.45

(57) ABSTRACT

The corkscrew of the invention is specially designed to ensure optimum functionality, while being extremely easy to use and having great structural simplicity, with the consequent positive effects in terms of costs and lifetime of the corkscrew. To this end, the support arm (7) of said corkscrew, with a channel-like configuration, is made as a single piece and incorporates within it a pivot element (11) mounted pivotably on a transverse pin or axis (10), said pivot element (11) ending at each end in respective support means (12 and 14), the first in the form of a claw and the second in the form of a hook, the first being located at the free end of the support arm and the second in the middle thereof, and the support surface of both being oriented outwards, i.e. towards the opening in the neck of the bottle when the corkscrew is placed on the bottle.

### OBJECT OF THE INVENTION

The present invention relates to a corkscrew, of the type of those used to open bottles of wine and the like, i.e., bottles closed by means of a cork stopper.

The objective of the invention is to achieve a corkscrew combining optimal functionality, together with a considerable handling simplicity, with an also considerable structural simplicity, with the consequent and positive repercussion at the level of costs and at the level of service life of the corkscrew itself.

### BACKGROUND OF THE INVENTION

There are on the market various types of corkscrews with different structural and functional criteria.

One of the typical solutions with a widespread use is the one in which the corkscrew is formed as a helix finished at its free end in a sharp tip, for the insertion into the stopper, and which at its other end is attached in an articulated manner to a handle intended to work as a second-class lever, for which purpose said handle is also attached in an articulated manner at one its ends to a support arm for said lever, specifically in a support arm on the opening of the bottle.

This solution, which is perfectly valid from the theoretical point of view, has in practice functional problems because if a long support arm is used, the maneuver for supporting the free end thereof on the opening of the bottle is difficult, on many occasions impossible, and a partial insertion of the helix into the stopper must be resorted to, with the consequent risk that the latter breaks, whereas if a short support arm is used, which prevents the mentioned problem, the removal of the stopper by means of a lever maneuver can only be performed partially, in a first phase which must be completed with a second phase in which the removal is performed by direct traction on the handle, without lever effect, with the considerable excessive force that this involves.

This problem has led to modifying the support arm of corkscrews of this type, such that two supports are established therein, one at the middle level and another one at the end level, the first being used in also first operative phase for removing the stopper, whereas the second support is used for removing the remaining sector of said stopper.

The direct arrangement of the two supports on the same arm is very problematic, given that the intermediate support usually collides laterally with the stopper when the end support is to be used, therefore in practice the support arm is divided into two arms which are physically independent from one another, connected by means of an articulation provided with a stop, such that the end and free sector of said arm can pivot with respect to the other sector thereof at a certain angle or with a certain margin, in order to determine two end positions, each of them corresponding to one of the two maneuvers for removing the stopper, and such that none of the two supports hinders the proper use of the other one.

Although this solution is perfectly valid from the point of view of results obtained with it, its fundamental problem is the structural complexity involved for the corkscrew by the participation therein of a support arm divided into two arms which are physically independent from one another and attached by means of an articulation, which furthermore generates problems for many new users, for whom it is difficult to correctly position the corkscrew in the two maneuvers for removing the stopper.

### DESCRIPTION OF THE INVENTION

The corkscrew proposed by the invention, which belongs to the group of corkscrews which allows removing the stopper in two successive phases and by means of respective maneuvers with a lever effect, fully and satisfactorily solves the problems set forth above.

To that end and more specifically, the proposed corkscrew, from the basic structuring of a conventional corkscrew of the type of those mentioned above, focuses its features on the incorporation of a single support arm, with the classic grooved or U-shaped section configuration, inside which there moves a rocker emerging through the free end of said grooved arm and forming through one of its ends the support on the opening of the bottle in the second phase for removing the stopper, during which said rocker is substantially fitted inside the grooved arm, whereas in the first phase for removing the stopper the mentioned rocker pivots, since its lower end is laterally supported on the neck of the bottle, its upper end emerging to the exterior, in the form of a hook which can be coupled to the opening of the bottle, which in turn allows carrying out the first phase or leverage operation in optimal conditions.

Otherwise, the corkscrew may be provided with the classic capsule-cutting blade, with the also classic notch acting as a decapsulator, or with any other type of accessory considered to be appropriate, without this affecting the essence of the invention at all, which is exclusively focused on the mentioned rocker, whereby the two supports for the arm on the neck of the bottle are achieved.

### DESCRIPTION OF THE DRAWINGS

To complement the description which is being made and for the purpose of aiding to better understand the features of the invention according to a preferred practical embodiment thereof, a set of drawings is attached as an integral part of said description, in which the following has been depicted with an illustrative and non-limiting character:

FIG. 1 shows, according to a side perspective view, an extended corkscrew, made according to the present invention, in which the arm appears in a situation of carrying out the first phase for removing the stopper.

FIG. 2 shows a perspective view opposite to that of the previous figure, also with the corkscrew extended, but with its support arm in a position corresponding to carrying out the second phase or definitive phase for removing the stopper.

FIG. 3 shows the corkscrew of the previous figures in a work situation, specifically in the first phase for removing the stopper from the bottle.

FIG. 4 finally shows a depiction similar to that of the previous figure, but corresponding to the second phase for removing the stopper.

### PREFERRED EMBODIMENT OF THE INVENTION

In view of the discussed figures, it can be observed how the corkscrew proposed by the invention propone is formed, like any conventional corkscrew of this type, from a helix (1) formed as a wire element arranged in the manner indicated by its name, finished at one of its ends in a sharp tip (2), whereas at its other end (3) it is attached in an articulated manner to a handle (4), with the collaboration of a transverse shaft or pin (5), the handle (4) adopting a grooved configuration, such that in an operative situation of the helix (1), the latter can be partially housed in the grooved inside of the handle (4).

As is also conventional, the handle (4) is attached in an articulated manner at one of its end and by means of a pin (6), to a support arm (7), also with a grooved configuration, i.e., with a U-shaped section, which is usually provided with a notch (8) acting like a decapsulator, as is especially observed in FIG. 2, and being able to incorporate, as is also usual in apparatuses of this type, a blade (9) acting like a capsule cutter, duly integrated and concealable inside the handle (4).

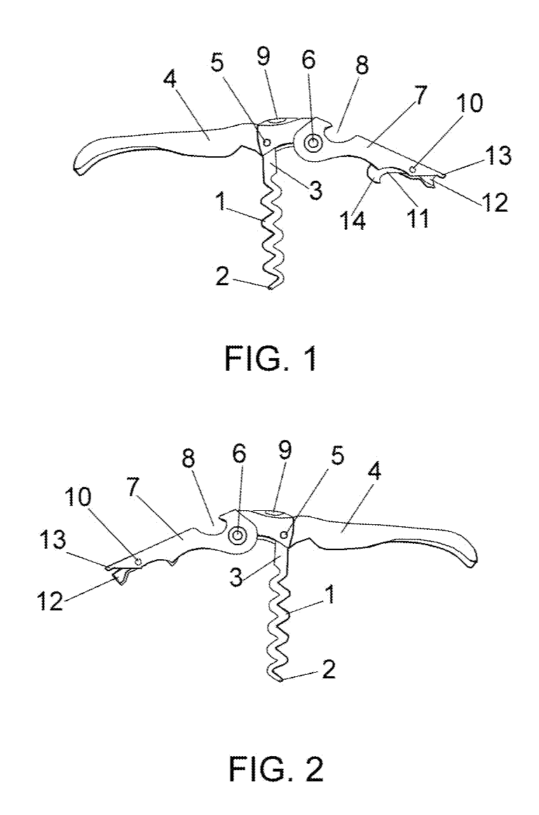

According to the invention, the mentioned support arm (7) is a single arm, with the suitable length, which relatively close to its free end incorporates a transverse pin (10) through which a rocker (11) is attached thereto in an articulated or pivotable manner, which rocker has, with respect to the grooved arm (7), suitable dimensions and an also suitable positioning for the pin (10), in order to allow a certain pivoting thereof between limits shown respectively in FIGS. 1 and 2, determined by the support of either end of the rocker (11) on the bottom of the groove defined by the bottom of the support arm (7).

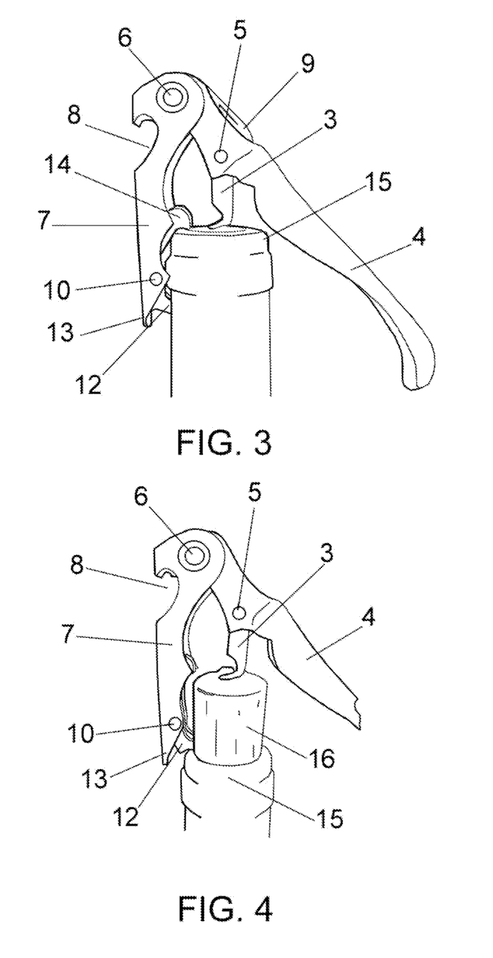

The rocker (11) is finished at its distal end in a support (12), in the form of a finger, which is recessed with respect to the free end of the arm (7), wherein the latter is extended through its middle branch, configuring a sort of step with the actual support (12), which step is especially visible in FIG. 2. In a complementary manner, the other end of the rocker (11) is configured in the form of a hook (14), with a concavity oriented towards the free end of the arm (7), especially visible in FIG. 1, which forms the other support of the corkscrew on the opening (15) of the bottle, which is observed in turn in FIG. 3.

According to this structuring and after the classic axial driving of the helix (1) into the stopper (16), the simple support of the arm (7) on the side of the neck of the bottle, makes the end (14) in the form of a hook of the rocker (11) be projected inwardly, being locked on the opening (15) of the bottle, as shown in FIG. 3, such that in this position and upon acting on the handle (4), the corkscrew acts like a second-class lever, causing the exit of approximately the first half of the stopper, until the position shown in FIG. 4.

At this time, the position of the arm (7) is changed such that the finger or support (12) impinges on the opening (15) of the bottle, causing in the first place a lateral pivoting of the rocker which makes the hook (14) retract toward an inoperative situation, as is also shown in FIG. 4, from which the lever type movement of the handle (4) determines the definitive exit of the stopper, or in other words, the complete removal of the stopper from the bottle.

Finally, it must only be added that the rocker (11) can be provided with full freedom of movement by its shaft or pin (10), or it can be aided by a strip or spring which tends to keep it in any of the two limit positions provided for it.

1.- A corkscrew, of the type of those which incorporate a helix intended to be axially coupled to the cork stopper, attached in an articulated manner at one of its ends to a handle which is in turn also attached in an articulated manner to a support arm on the opening of the bottle, characterized in that the mentioned support arm (7) with the classic grooved configuration is made as a single piece and incorporates therein a rocker (11) assembled with the possibility of pivoting on a transverse shaft or pin (10), said rocker (11) being finished at its ends in respective supports (12 and 14), the first being in the form of a finger and the second being in the form of a hook, the first being located at the free end of the support arm and the second at a middle level thereof, and both of them having their support surface oriented outwardly, i.e., towards the opening of the neck of the bottle in a situation of assembly of the corkscrew on the latter.

2.- The corkscrew according to claim 1, characterized in that the pivoting axis (10) of the rocker (11) is located substantially close to the free end (13) of the support arm (7), whereas the other end (14) of the mentioned rocker is located substantially in the middle area of the arm (7).

3.- The corkscrew according to the previous claims, characterized in that the support arm, with the classic grooved or U-shaped section, has the free end of its middle branch extended with respect to its side branches, defining with the corresponding finger of the rocker a step for support on the opening of the bottle.

4.- The corkscrew according to the previous claims, characterized in that the transversal shifting of the finger (12) is considerably less than the transverse shifting of the hook (14), in the pivoting movement of the rocker (11).
